(19) United States
(12) Patent Application Publication
(10) Pub. No.: US 2009/0058219 A1
(43) Pub. Date: Mar. 5, 2009

(54) SLIP RING FOR CONTINUOUS CURRENT TRANSFER

(75) Inventors: Bernd GEHLERT, Bruchkobel (DE); Rolf PAULSEN, Hanau (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: W.C. HERAEUS GMBH, Hanau (DE)

(21) Appl. No.: 12/062,614

(22) Filed: Apr. 4, 2008

Related U.S. Application Data
(63) Continuation of application No. PCT/EP2006/009651, filed on Oct. 5, 2006.

(30) Foreign Application Priority Data
Oct. 5, 2005 (DE) 10 2005 047 799.2

(51) Int. Cl. H01R 39/08; H01R 43/10

(52) U.S. Cl. 310/232; 29/597

(57) ABSTRACT

A slip ring has a substrate material and a sliding contact surface made of gold or a gold alloy. The sliding contact surface is stabilized by a support base. The slip ring is used in slip ring transmitters, in particular in wind power plants or industrial robots, for transmitting control signals and control currents and generator currents. An extended service life, in conjunction with improved quality, a reduced drop in voltage and considerable savings in the amount of gold used can be achieved with the slip ring.

### CROSS-REFERENCE TO RELATED APPLICATIONS

This application is a Continuation of International Application No. PCT/JP2006/009651, filed Oct. 5, 2006, which was published in the German language on Apr. 12, 2007, under International Publication No. WO 2007/039302 A1 and the disclosure of which is incorporated herein by reference.

### BACKGROUND OF THE INVENTION

The present invention relates to slip rings for slip ring transmitters for continuous current 10 transfer and to a galvanic method for the manufacture thereof.

Rotating current transmitters having contact systems made of stainless steel or a precious metal coating are used predominantly where demanding requirements with regard to the quality of current transmission (voltage variation during the rotation), service life, and ease of maintenance exist. A distinction is made between sliding contacts with and without interruption of current:
Uniform motion of the sliding contacts over an interrupted sliding track (miniature DC motors)
Sliding of the pick-off contact, with current flowing, via contact segments into a new resting position (rotary switch, sliding-dolly switch)
Uniform motion of the sliding contacts over a closed sliding track (slip ring transmitter)

Typical as designs for continuous current transfer are cylindrical slip ring transmitters or flat transmitter systems with printed boards. The electric load spectrum ranges from data transmission (<1 A) to energy transmission (100 to 500 A). Depending on the application, multiple sliding contacts made of precious metal may be arranged in parallel on a sliding track for the transmission of higher currents (>2 A). By this means, load currents of up to 500 A can be transmitted in cable drums of crane facilities, welding robots or generator applications in wind power plants.

A simple application of gold-cobalt on a nickel-plated, copper-based substrate shows variations in its drop in voltage and therefore interference with the quality of transmission. After approximately 3 to 5 million revolutions, the drop in voltage increases very significantly, such that the slip ring transmitter is no longer usable.

Galvanic layer systems comprise at least two different layers on a substrate. Common galvanic layer systems for current transmission comprise, on a brass substrate, a copper layer of approximately 0.5 μm in thickness and a nickel layer of approximately 2 to 5 μm thickness, which is being applied thereon and on which, in turn, a gold-copper-cadmium layer of 5 to 15 μm in thickness is applied. Using this layer system, a longer service life can be achieved as compared to simple galvanic layers on a substrate. However, a markedly higher drop in voltage, as compared to a simple gold-cobalt coating, must be tolerated in this context. Moreover, cadmium is undesirable for ecological or health reasons.

### BRIEF SUMMARY OF THE INVENTION

It is an object of the present invention to cause the drop in voltage to be lesser in extent and more uniform, and further to increase the service life of the system.

The above object is achieved according to the invention by a slip ring having a substrate material and a sliding contact surface made of gold or a gold alloy, in which the sliding contact surface is stabilized by a support base.

According to an embodiment of the invention, the sliding contact surface is provided on a hard support to be thinner than has been common hitherto. This allows reduction of the drop in voltage at thus far unattainable quality (variations in the drop of voltage) up to 5,000,000 revolutions to a constant value that is clearly below 0.5 V at 2 A. In the further course, up to at least 10,000,000 revolutions, the quality attained is at least as good as has been attainable for the first 1,000,000 revolutions according to the prior art.

In any case, the hardness must be higher than the hardness of the nickel that has been used as a diffusion barrier layer thus far. Metals of the platinum group and phosphorus-doped nickel have sufficient hardness for the present invention. The slip ring transmitters according to the invention are suitable for all applications of electrical energy and data transmission for rotating systems, in particular wind power plants, robots, welding robots, cable drums, and radar facilities, which have in common that a fixedly attached current connection would be unsuitable.

Preferably, the thickness of the layer of the sliding contact surface made of gold or a hard gold alloy is reduced significantly. Accordingly, not only a substantial reduction in the amount of gold used is facilitated according to the invention, but the service life is also increased. In this context, the present invention facilitates a reduction of the application-specific suitable thickness of the layer of sliding contact surface made of gold or hard gold by at least 30%, preferably at least 50%. It has been proven useful for the thickness of the layer to be less than 10 μm, preferably 1 to 5 μm, more preferably 2 to 3 μm, in particular in the application of precious metal slider wires made of Hera 277 (AuPdAg alloy) from W.C. Heraeus GmbH of Hanau, Germany. The application of gold becomes increasingly uneconomical beyond 15 μm. Abrasion determines a minimal layer thickness related to the service life.

It is sensible for the sliding contact surface of a sliding contact track to be in the form of a track. The track can be arranged axially on the surface of a disk or radially on the outside of a ring.

As a track on a sliding contact disc, the sliding contact surface is sensibly provided to be disk-shaped. Multiple tracks can be arranged radially adjacent to each other on a disc. Printed boards have proven useful for this embodiment.

As a track on a sliding contact ring, the sliding contact surface is sensibly provided to be ring-shaped. Multiple rings can be arranged axially on an axis.

It has proven useful for sliding contact surfaces to be made of a gold alloy that comprises cobalt or nickel. Suitable gold-cobalt alloys or gold-nickel alloys comprise 50 to 99.8 wt-% gold, 0.2 to 20 wt-% cobalt or nickel, 0 to 30 wt-% of further alloy components. Suitable further alloy components are further precious metals, copper, and doping with boron, carbon, silicon, or phosphorus.

The support base, in particular an intermediate layer that is arranged on a nickel-plated substrate, comprises a hard material that supports the sliding contact surface, in particular of the hardest material of the composite. A support basis, in particular an intermediate layer made of one or more metals of the platinum group (PGM) or alloys thereof or hardened nickel have proved useful. Suitable minor alloy components include nickel, cobalt and iron, and doping with boron, carbon, silicon, or phosphorus to save on the amount of PGM used. Galvanic deposition of Pd on a nickel-plated substrate made of a copper alloy, for example brass, bronze or CuZr, has proven useful. Metals of the platinum group can be replaced by iron metals to a limited extent. Doping with B, C, Si, or P increases the hardness.

It has also proven useful to apply the harder intermediate layer onto a diffusion barrier layer made of nickel. Providing an intermediate layer made of phosphorus-hardened nickel allows saving on the amount of platinum group metals. A preferred embodiment has a diffusion barrier layer made of nickel arranged on a copper-based substrate, such as brass. An intermediate layer made of phosphorus-hardened nickel is applied onto the nickel diffusion barrier layer. A nickel-containing hard gold layer is applied onto the hardened nickel to serve as a sliding contact surface. These three layers are characterized by their simplicity. Diffusion of nickel is insignificant, since all three layers contain nickel. Phosphorus is not known to diffuse.

Intermediate layers having a thickness of less than 10 μm, preferably 2 to 7 μm and more preferably 3 to 4 μm, have proven useful. It has proven useful to provide the intermediate layer to be thicker than the sliding contact surface.

The electrically conducting composite comprising the sliding contact surface and the intermediate layer supporting it is advantageously provided to have a thickness between 3 and 10 μm, preferably between 4 and 8 μm, and particularly advantageously between 5 and 7 μm.

Preferably, the electrically conducting substrate is a copper alloy. Copper alloys for continuous current transfer that have proven to be useful contain zinc (brass), tin (bronze) or zirconium.

The supporting base can be separated from the sliding contact surface by a thin layer, for example a diffusion barrier layer or a bonding agent. It is recommended that a layer of this type be no more than 1 μm in thickness, since the supporting function of the supporting base is negatively affected by increasing thickness of the thin layer.

The sliding contact surface, having a base that is hardened according to the invention, is used as surface of a slip ring transmitter (in particular in wind power plants or industrial robots) for the transmission of control signals, control and generator currents.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a graph showing the drop in voltage as a function of the revolutions for the sliding contact surface according to an embodiment of the invention;

FIG. 2 is an oscillogram at the start of the rotating current transfer according to an embodiment of the invention;

FIG. 3 is an oscillogram of the embodiment of FIG. 2 after 4,000,000 revolutions;

FIG. 4 is an oscillogram of the embodiment of FIG. 2 after 10,000,000 revolutions;

FIGS. 5a and 5b are transverse sectional, schematic views of two embodiments (Examples 1 & 2) of slip ring transmitters according to the invention;

FIG. 6 is a schematic diagram of an experimental set-up for determination of the drop in voltage and of the quality of a slip ring according to the invention;

FIGS. 7 to 9 are graphs similar to FIG. 1 showing drop in voltage as a function of revolutions for three comparative examples of sliding contact surfaces;

FIGS. 10 to 12 are oscillograms similar to FIG. 2 at the start of the rotating current transfer for the three comparative examples of sliding contact surfaces as in FIGS. 7 to 9;

FIGS. 13 to 15 are oscillograms similar to FIG. 3 at intermediate numbers of revolutions for the three comparative examples of sliding contact surfaces as in FIGS. 10 to 12;

FIGS. 16 to 18 are oscillograms similar to FIG. 4 at final numbers of revolutions for the three comparative examples of sliding contact surfaces as in FIGS. 13 o 15.

### DETAILED DESCRIPTION OF THE INVENTION

### Example 1

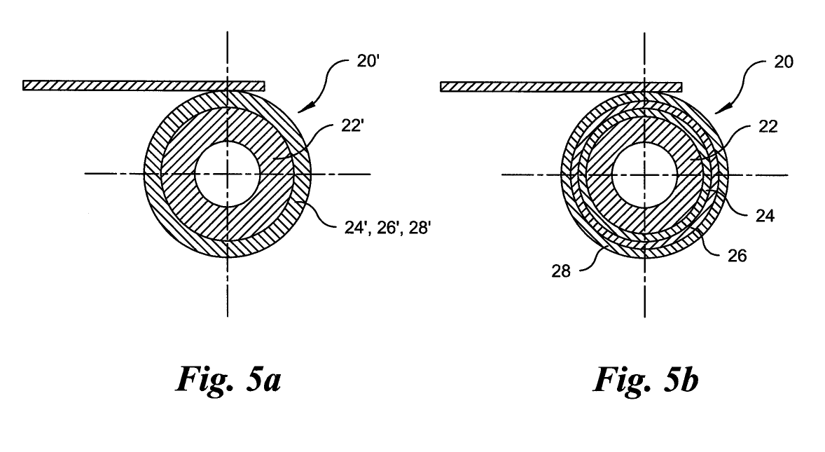

In a simple embodiment (FIG. 5b), a current transmitter 20 is provided in the form of a ring, wherein the sliding contact surface is arranged on the outer surface of the ring. In order to manufacture a ring of this type, 2 μm of nickel 24 are deposited by galvanic means on the outside of a brass or bronze ring 22 and 5 μm of nickel-phosphorus 26 are deposited thereupon. The nickel in the nickel-phosphorus layer 26 is doped with phosphorus, and the layer 26 is therefore significantly harder than the nickel layer 24, which is situated underneath the nickel-phosphorus layer 26. Four μm of a gold-nickel alloy 28 are deposited by galvanic means onto the phosphorus-doped nickel layer 26.

Compared to a slip ring transmitter having no hardened nickel layer, this slip ring achieves improved quality of current transfer and higher wear and tear resistance.

### Example 2

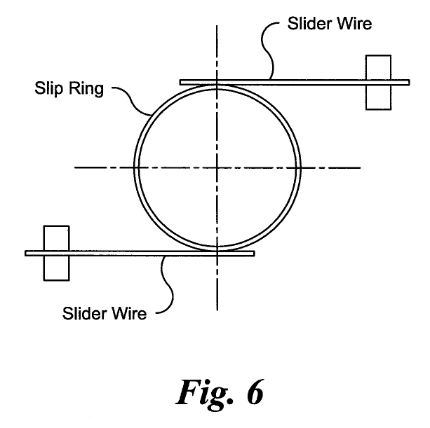

In a further embodiment (FIG. 5a), the outside of a brass ring 22′ is provided with a nickel layer 24′ of 4 μm by galvanic means. Galvanic means are used to apply a palladium layer 26′ of 5 μm onto this nickel layer 24′. A galvanic hard gold alloy 28′ made of gold and cobalt having a thickness of 5 μm is applied onto the palladium layer 26′. The current transmitter 20′ thus created is analyzed in a set up according to FIG. 6. The two slider wires 1 and 2 are run on different tracks.

Experimental parameters:
Electrical load: 24 V DC/2 A/ohmsch,
Contact force: 2 to 3 cN,
Spring length: 45 mm,
Slider wire: d=0.5 mm,
Slip ring: d=60 mm,
Rotating speed: 300/min.,
Greasing: none,
Number of revolutions: 10,000,000
The sliding contact is made of Hera 277 (AuAgPd alloy).

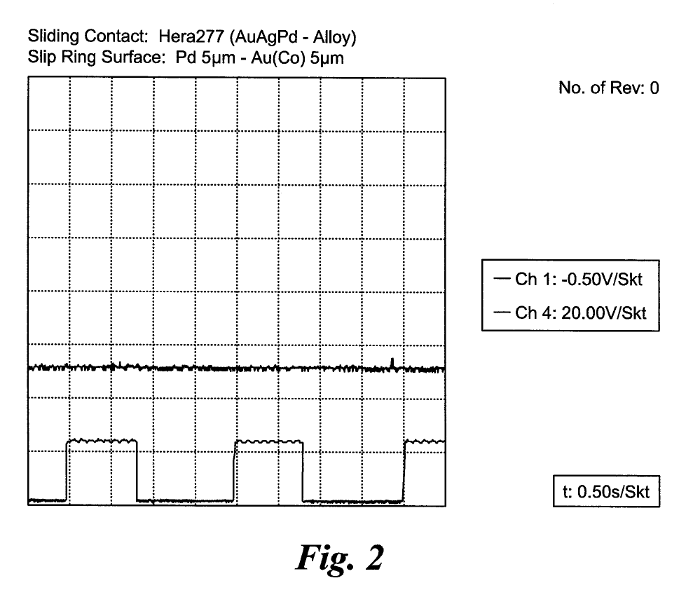

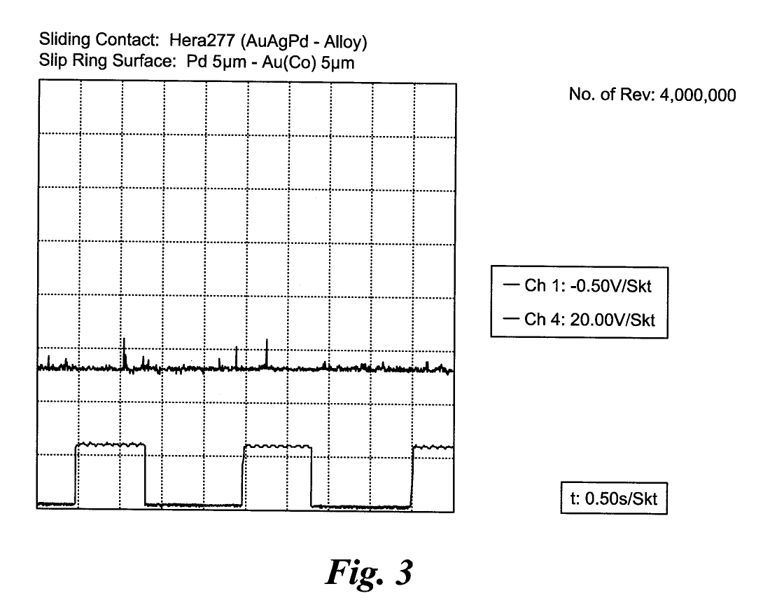

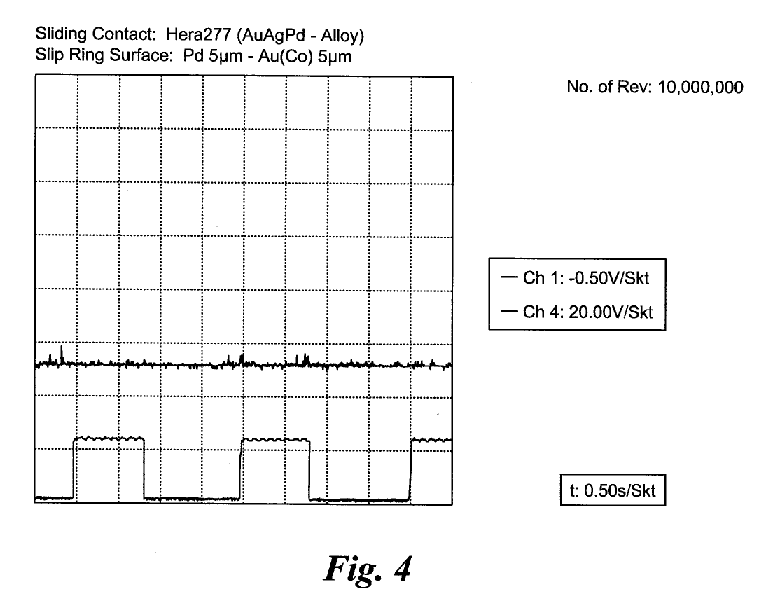

The oscillogram according to FIG. 2 shows the drop in voltage at the start of the experiment. The oscillogram according to FIG. 3 shows the drop in voltage after 4 million revolutions, and the oscillogram according to FIG. 4 shows the drop in voltage after 10 million revolutions. In all oscillograms, the trigger signal is recorded as a square-wave pulse. The zero line for the voltage signal is always the upper line of the second box from the bottom.

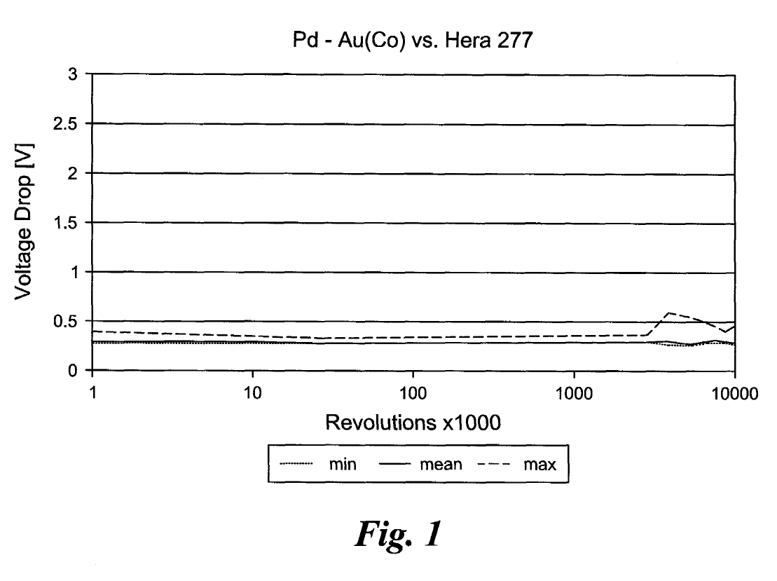

The drop in voltage as a function of the revolutions is shown in the graph according to FIG. 1. The dashed line represents the upper value from the oscillograms, the dotted line represents the lower value, and the continuous line represents the mean.

### Comparative Examples 1-3

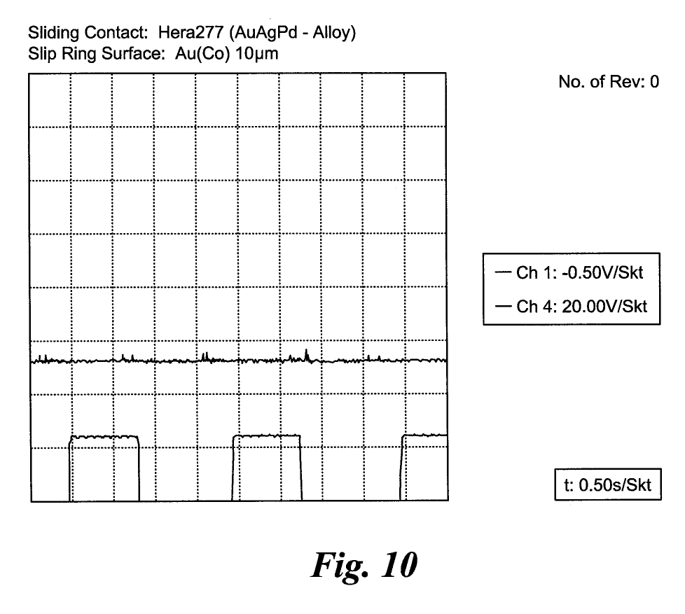

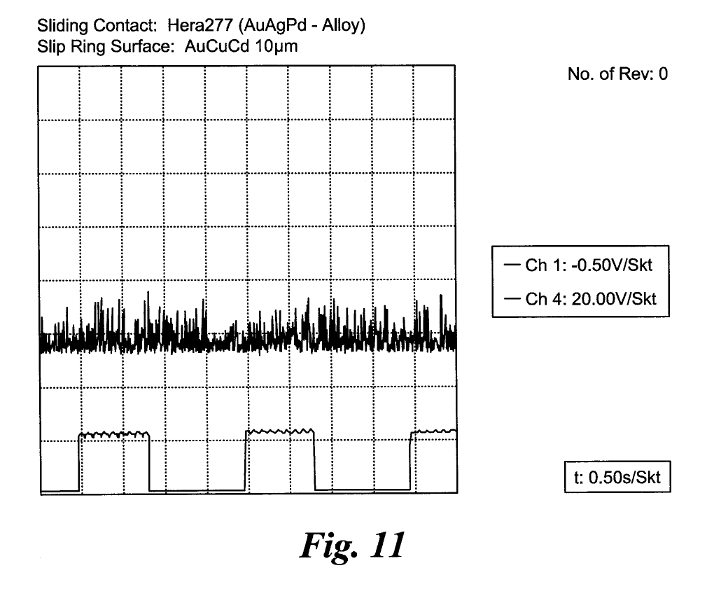

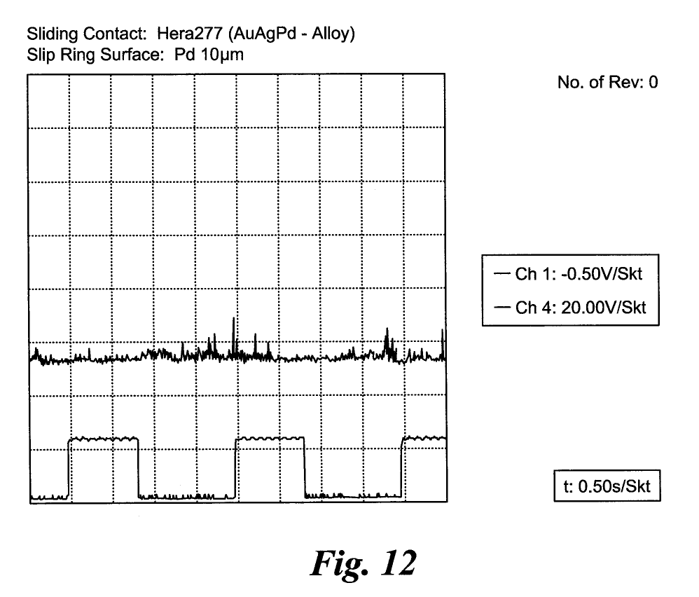

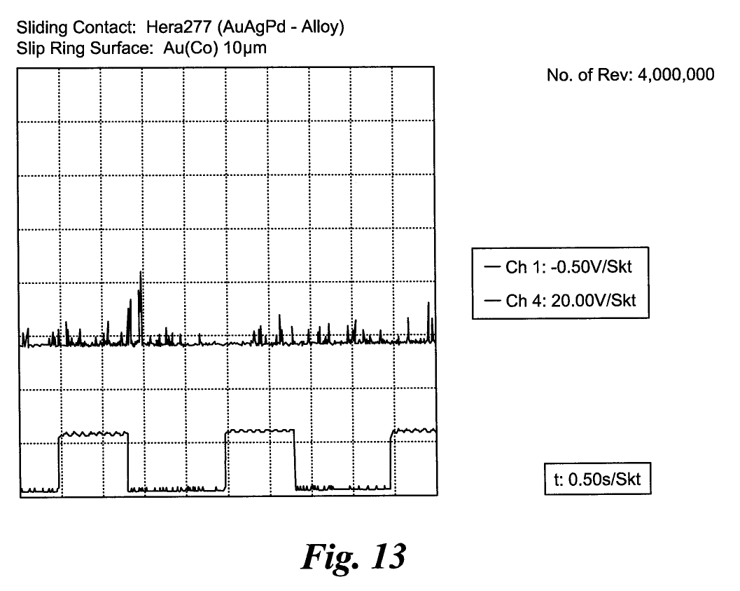

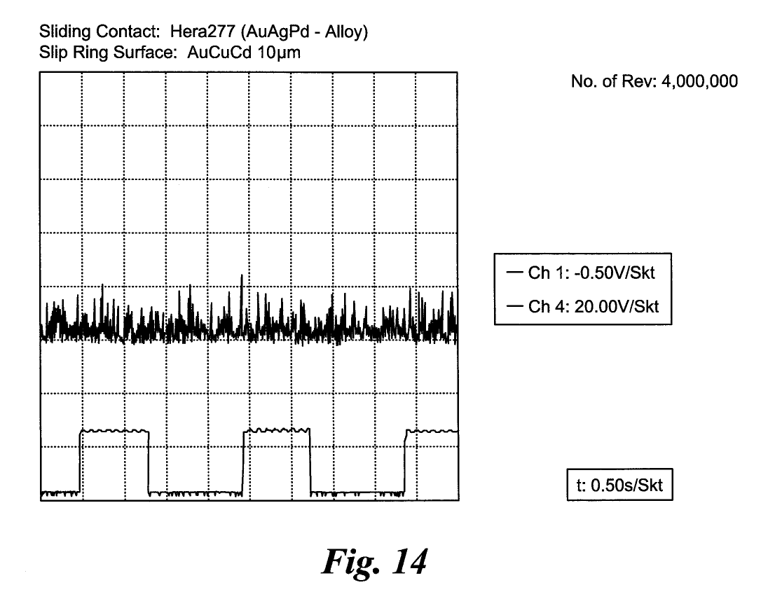

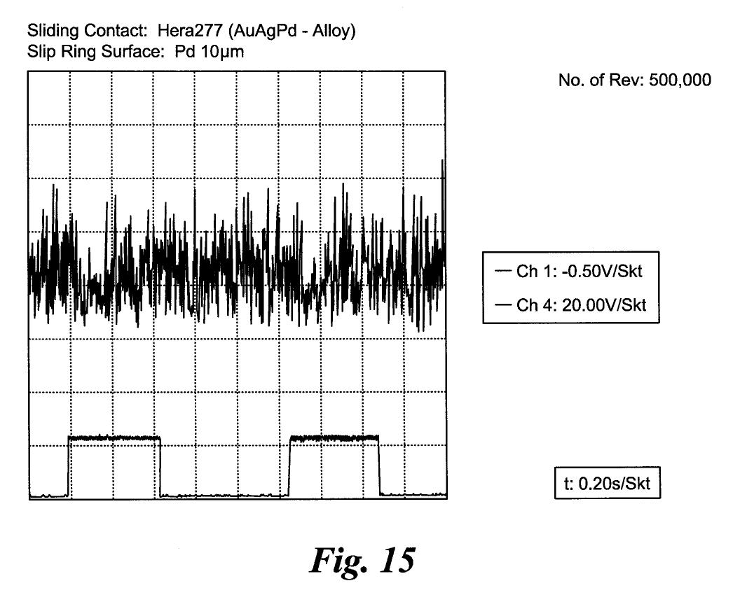

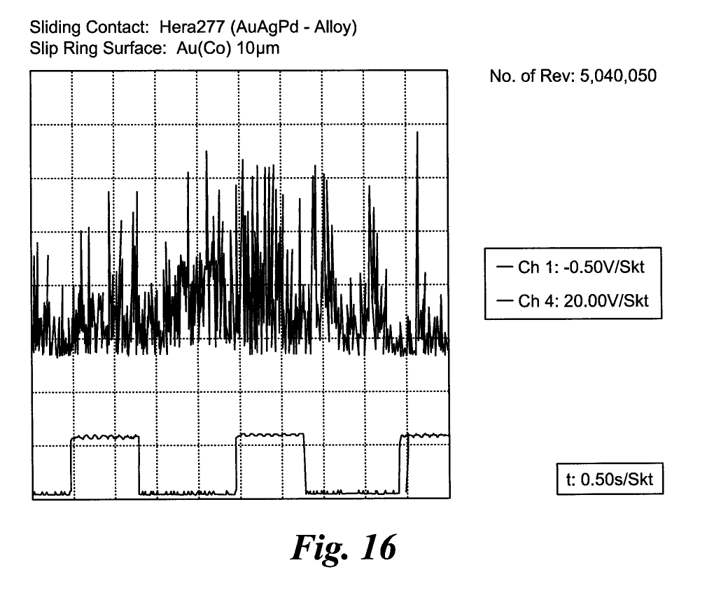

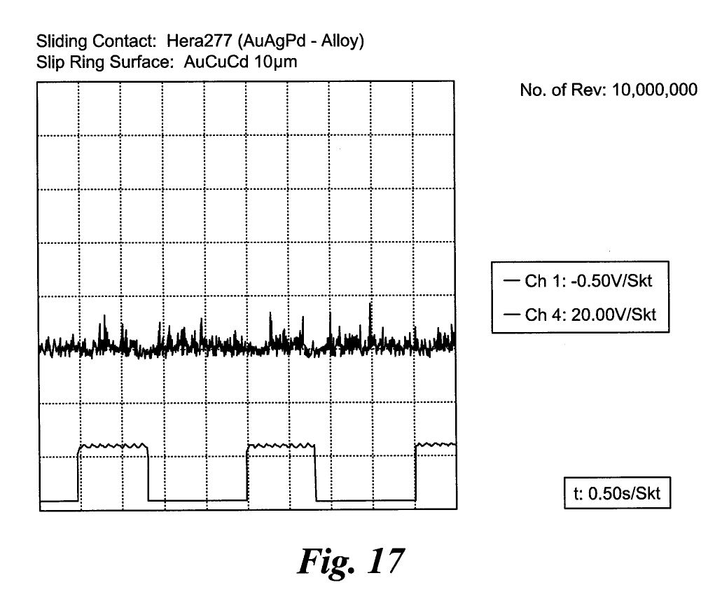

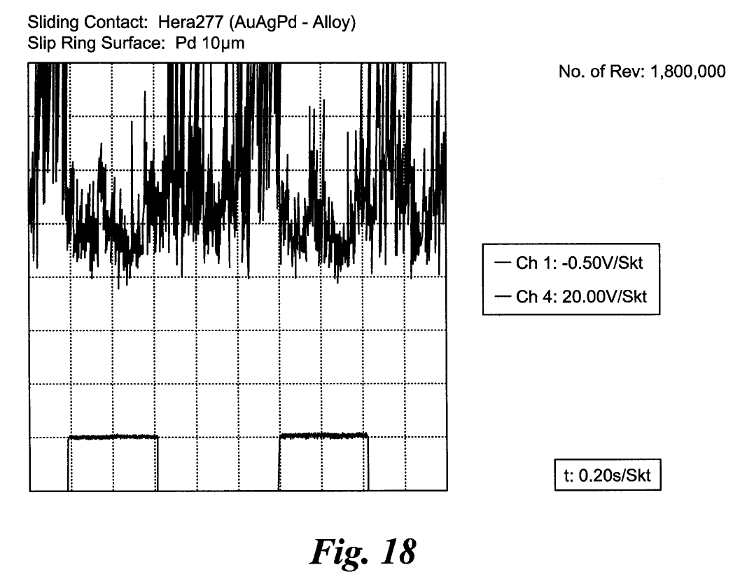

For comparative purposes, three slip rings having 10 μm sliding contact surfaces made of AuCo, AuCuCd, and Pd each are examined on a nickel-coated brass support under identical experimental conditions according to Example 2. Since the slip rings having the AuCo and the Pd sliding contact surface did not survive 10 million revolutions, oscillograms for correspondingly fewer revolutions were compared (FIGS. 15, 16, and 18). The oscillograms of FIGS. 10, 13, and 16 were recorded using an AuCo sliding contact surface, whereas the oscillograms of FIGS. 11, 14, and 17 were recorded using an AuCuCd sliding contact surface, and the oscillograms of FIGS. 12, 15, and 18 were recorded using a Pd sliding contact surface.

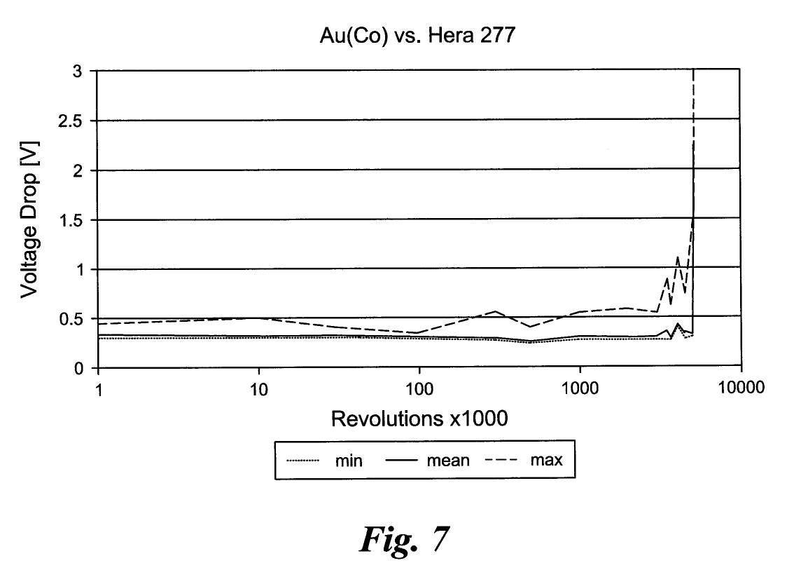

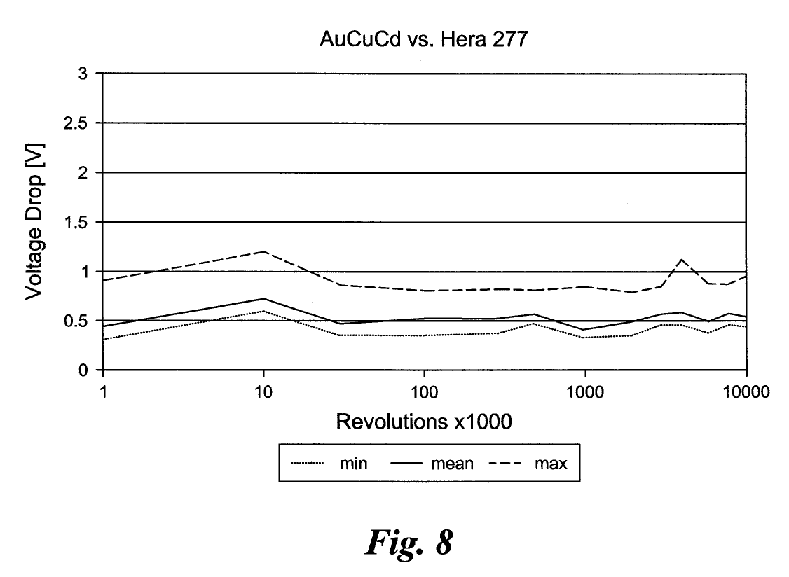

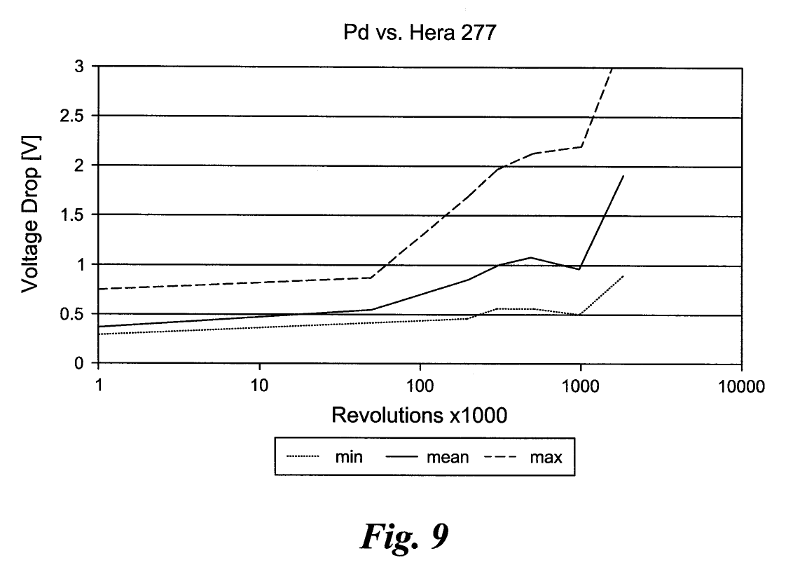

The drop in voltage as a function of the revolutions in FIGS. 7 to 9 is presented analogously to FIG. 1.

### Example 3

Multiple slip rings can be stacked axially on an axis. Accordingly, multiple current paths exist. For the application of high electric currents, multiple current paths are connected in parallel. In an alternative arrangement, multiple slider tracks can be arranged radially on a disc. In this case, one of the surfaces of the disc is coated analogous to what has been described previously for the outer surfaces of the rings.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A slip ring comprising a substrate material and a sliding contact surface made of gold or a hard gold alloy, wherein the sliding contact surface is stabilized by a support base.

2. The slip ring according to claim 1, wherein the support base is harder than nickel.

3. The slip ring according to claim 1, wherein the support base is an intermediate layer between the contact surface and a substrate.

4. The slip ring according to claim 1, wherein the hard gold alloy comprises nickel or cobalt.

5. The slip ring according to claim 4, wherein the hard gold alloy comprises 50 to 98 wt.-% gold, 0.02 to 20 wt.-% of at least one of cobalt and nickel, 0 to 30% further alloy components.

6. The slip ring according to claim 5, wherein the further alloy components comprise one or more selected from copper, silver, palladium, platinum, rhodium, iridium, ruthenium, boron, carbon, silicon, and phosphorus.

7. The slip ring according to claim 1, wherein the support base is based on at least one metal of the platinum group or nickel-phosphorus (phosphorus-doped nickel) or a double layer comprising nickel and nickel-phosphorus.

8. The slip ring according to claim 1, wherein the support base is an intermediate layer between the contact surface and a substrate.

9. A slip ring transmitter for transmitting control signals, control currents and generator currents, the transmitter comprising the slip ring according to claim 1.

10. The slip ring transmitter according to claim 9, which is present in wind power plants or industrial robots.

11. The slip ring according to claim 1, wherein the gold or hard gold alloy has a layer thickness for a special application, the layer thickness being reduced to maximally 70% of a thus far lowest thickness for the application.

12. The slip ring according to claim 11, wherein the gold or hard gold alloy has a layer thickness reduced to 10 to 50% of the thus far lowest thickness for the application.

13. A method for manufacture of a slip ring for continuous current transfer, the slip ring having a sliding contact surface, an electrically conductive substrate and an intermediate layer arranged between the substrate and the sliding contact surface, the method comprising galvanically depositing the intermediate layer onto the substrate, and galvanically depositing gold or hard gold onto the intermediate layer, wherein the intermediate layer comprises a material harder than nickel.
